(19) United States
(12) Patent Application Publication
(10) Pub. No.: US 2006/0251853 A1
(43) Pub. Date: Nov. 9, 2006

(54) Method and apparatus for making carpet

(76) Inventor: William O. Ingram III, Valley, AL (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/124,991

(22) Filed: May 9, 2005

(51) Int. Cl. B32B 33/00

(52) U.S. Cl. 428/95

(57) ABSTRACT

Methods and apparatuses for making improved carpet are disclosed comprising the use of plasma discharge units to treat carpet backing surfaces to improve the adhesion of carpet backing layers, the adhesion of carpet backing to the carpet segments and to improve the adhesion of the exterior of the carpet backing to surfaces to which the carpet is applied.

### FIELD OF THE INVENTION

The present invention is directed generally to improved methods and apparatuses for manufacturing carpet. More specifically, the present invention is directed to the use of specific surface treatments for treating carpet backing layers to improve quality and characteristics of the finished carpet.

### BACKGROUND OF THE INVENTION

In the field of carpet manufacture, a stabilized backing layer is usually affixed to the carpet segment. Well known web processes exist in the carpet manufacturing field that produce a carpet backing layer that is then applied to the carpet segment. Such a backing layer is applied to the carpet segment to provide the finished carpet with needed rigidity and stability. In one known process, a molten polyolefin film or layer is applied to both sides of a rigid or semi-rigid substrate to construct a three-layer laminate backing. As the backing proceeds along the web, carpeting is supplied to the web and brought into contact with the backing. The backing is affixed to the carpet segment via heat and pressure to produce the completed carpet.

From a quality control standpoint, the backing layer must sufficiently adhere to the carpet segment for the useful life of the carpet. Trial and error in the industry has led to various practical standards in terms of the amounts, thicknesses and characteristics of the materials used for carpet backing construction. To produce the required adherence of the backing layer to the carpet, certain types of materials must be used, or else undesirable delamination may occur. In addition, the selected backing materials must have a certain thickness, density, tensile strength, etc. or risk the same backing delamination or backing separation from the carpet layer. By regulating the practical amount of backing material that must be used to achieve the required adherence of the backing layer, the weight of the backing layer necessarily affects the finished overall weight of the carpet. In addition, since adherence of the backing to the carpet is dependent upon the physical characteristics of the backing material, the known workable material candidates for use in backing material manufacture have been restricted to certain preferred polyolefins. These preferred polyolefins have shown the required properties to maintain the desired carpet quality and performance. However, this fairly narrow class of preferred polyolefins, which have proven to possess the appropriate and necessary physical and chemical properties, are often relatively expensive materials that must be used in their virgin state to assure desired material performance.

Such practical constraints on backing material type have impeded the continued improvement of carpet technology, at least in terms of flexibility and variety of material selection, amount of material used, and the overall weight of the finished carpet. This, in turn, has had a direct effect on the overall production and installation cost of the finished carpet product.

### SUMMARY OF THE INVENTION

The present invention is directed to an improved carpet manufacturing process enabling the use of a broader variety of backing materials, to potentially include recyclable and non-virgin materials. In addition, the present invention is directed to an improved carpet manufacturing process that can reduce the useful thickness of the backing material while maintaining the adequate backing adherence to the carpet layer and the overall carpet performance. Still further, the present invention contemplates a carpet manufacturing process that facilitates carpet installation by modifying the backing layer.

The present invention is also directed to the surface modification of composite layers used in the manufacture of carpet backing. More specifically, the present invention is directed to modifying the surface of materials used to make carpet backing by disrupting the physical or chemical nature of a material surface through the exposure of corona discharge and/or ozone treatment.

In a still further embodiment, the present invention is related to a process for making a carpet comprising the steps of providing a stabilizing component to a web, with the stabilizing component having a first and a second surface. A surface modifying treatment is provided located proximate to the first surface of the stabilizing component and applied to the first surface of the stabilizing component. A material is provided to the first surface of the stabilizing component following surface treatment of the first and/or second surface of the stabilizing component. A second material is provided to the second surface of the stabilizing component and a carpet segment is provided to a web in close proximity to the second material on the stabilizing component. A surface modifying treatment is provided and applied to the second material followed by contacting and adhering the carpet to the surface-treated second material.

In addition, the present invention is directed to a carpet comprising a carpet component and a backing component. The backing component comprises a stabilizing component having first and second surfaces, with a thermoplastic material coating both surfaces in a total amount of from about 70 oz/yd² to about 120 oz/yd².

The present invention is further directed to a method for making carpet comprising the steps of providing a first substrate to a web, the first substrate having a first and a second surface. A surface modifying treatment process is located proximate to the first surface of the first substrate and applied to the first surface of the first substrate component. A second substrate is adhered to the first surface of the first substrate following the surface treatment of the first surface of the first substrate. A carpet component is then adhered to the second substrate after a pre-coated backing surface of the carpet component has been optionally surface-treated.

Still further, the present invention is directed to a carpet comprising a backing component having a first substrate surface that is corona plasma-treated, with the first substrate surface of the backing component in contact with a first surface of a second substrate, and a carpet component adhered to a second surface of the second substrate.

### BRIEF DESCRIPTION OF THE DRAWINGS

FIG. 1 shows a schematic representation of one process of the present invention for manufacturing carpet by treating backing layers and assembling a carpet on a web.

FIG. 2 shows a perspective view of the carpet with adhered backing showing treated surfaces.

FIG. 3 shows a schematic representation of a process for manufacturing carpet by treating the backing foam layer on a web.

FIG. 4 shows a perspective view of the carpet made according to the process shown in FIG. 3 with adhered backing layer.

### DETAILED DESCRIPTION OF THE INVENTION

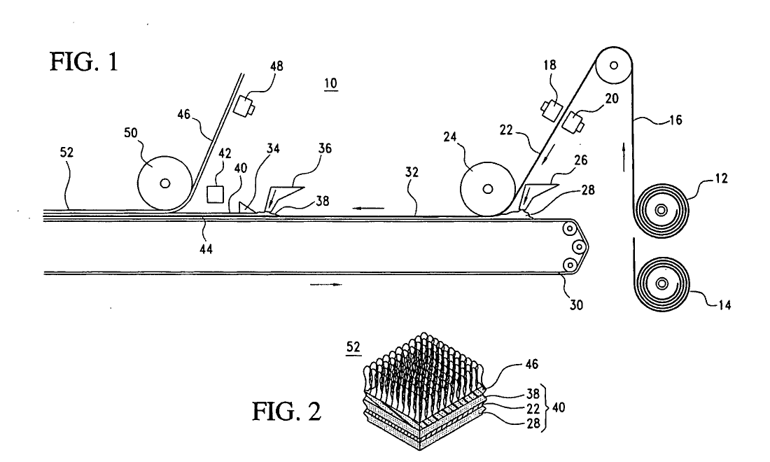

FIG. 1 shows a side view schematic representation of one embodiment of the present invention whereby an improved carpet is assembled on a web 10. Fiberglass rolls 12 or 14 provide fiberglass 16 to the web 10. Corona treatment units 18, 20 are provided to one or both sides of the fiberglass 16 to obtain a treated fiberglass 22, which proceeds to a calendar roll 24. A flow of molten thermoplastic material is delivered via conduit 26 to obtain a polyolefin puddle 28 on Teflon® belt 30. The pressure of the calendar roll 24 against the Teflon®-coated belt 30 with interposed treated fiberglass 22 with the thermoplastic material 28, creates a layer of thermoplastic on a first surface, or “underside” of fiberglass 22 said polyolefin layer having a predetermined thickness. The once-thermoplastic-coated fiberglass 32 layer proceeds along the web to a second or thermoplastic material deposit station where a flow of thermoplastic material is distributed via conduit 36 onto a second surface, or “top” of the fiberglass layer 32 to create a puddle of molten thermoplastic 38. The thermoplastic material 38 encounters a knife edge 34 to create a layer of polyolefin on the “top” of the fiberglass 34 to a predetermined thickness, and creating a twice-thermoplastic-coated fiberglass layer 40. Layer 40 then proceeds past an ozone dispensing array 42 that treats the polyolefin applied to the “top” of the fiberglass. The ozone-treated polyolefin/fiberglass/thermoplastic finished backing layer 44, then substantially simultaneously contacts the carpet segment of carpet 46 provided from rolls (not shown). A carpet backing surface of carpet segment 46 is optionally treated with a corona treatment station 48, and is then brought into contact with the finished backing layer 44 at the press roll 50 used to apply pressure to the carpet segment 46 applied to the finished backing layer 44 to produce the finished reinforced carpet 52. The preferred thermoplastic material is a polyolefin, or is a polyvinylchloride (PVC)-containing compound. It is understood that the preferred polyolefin may be a thermoset or thermoform material, and may be in a recycled, or other non-virgin state. The preferred carpet backing is made from an EVA-containing material such as EVA hot melt, styrene butadiene rubber latex, polyvinyl chloride, polypropylene, polyacetic acid, polyethylene, polyamide, polyester, natural rubber, or polyvinyl butyral, etc.

FIG. 2 shows a cross-sectional perspective view of the finished reinforced carpet 52 made according to the process of FIG. 1. Finished reinforced carpet 52 comprises carpet segment 46 adhered to the backing layer composite 40, which itself comprises fiberglass layer 22 sandwiched between polyolefin layers 38, 28.

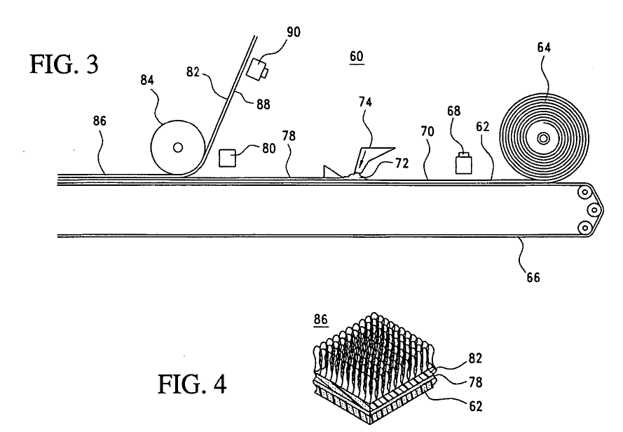

FIG. 3 shows a side view schematic representation of one embodiment of the present invention whereby an improved carpet is assembled on a web 60. In this embodiment, fiberglass reinforcement in the embodiment used and shown in FIG. 1 has been replaced by a “cushion” back or “recycle” back material 62 provided to the web 60 from roll 64. The cushion back material is preferably made from a material including, for example, polyvinyl chloride, polyurethane, polyethylene, vinyl nitrile, polyvinyl butyral, polyacetic acid, polyamide, polypropylene, styrofoam, polyester, styrene butadiene rubber, polyolefins, silicone, etc. In addition, the cushion back material may be made from nonwoven materials from any polymers that can be extruded into staple fiber or any natural fiber, i.e. 3-dimensional-nonwoven fabrics such as polypropylene, polyester and other polymers, etc.; 3-dimensional-honeycomb structures made from polypropylene, polyester and other polymers; or any other foamable or cushioning material. The cushion back material 62 proceeds on a Teflon®-coated belt 66 to corona treatment unit 68 where a first, or “upper” surface of the cushion back material 62 is corona-treated. The corona-treated surface 70 encounters a deposit of polyolefin material or “puddle” 72 provided to the surface 70 via dispensing array 74. The web is drawn past and under knife edge 76 to effect a thermoplastic layer 78 on the corona-treated cushion back surface 70, with said thermoplastic layer 78 delivered to a predetermined thickness. The thermoplastic layer 78 on the treated cushion back surface 70 is then drawn on the web 60 to an ozone dispensing array 80. A backed carpet segment 82 is delivered to the web 60 proximate to the ozone dispensing array 80 such that the dispensed ozone is delivered to the thermoplastic layer 78 and is physically trapped between the carpet segment 82 and the thermoplastic layer 78 substantially simultaneously as they pass beneath roller 84. The combined material becomes the finished carpet 86. The backing 88 of the carpet segment 82 is optionally corona-treated as it passes corona-treatment station 90.

FIG. 4 shows a cross-sectional perspective view of the finished reinforced carpet 86 made according to the process of FIG. 3. Finished reinforced carpet 86 comprises carpet segment 82 adhered to the layer 78, which is itself adhered to the cushion back or recycled back material 62.

As shown in FIG. 1, the corona discharge treatment of the stabilizing component in a carpet backing layer, preferably fiberglass, is positioned to take full effect of the surface treatment by bringing the preferred molten material, such as, for example, a thermoplastic material such as poly(vinyl chloride), polyvinylbutyral (PVB), bitumen, polymerically-modified bitumen, recycled material polymer mixtures, or other thermoplastic backing material, in either a solid, molten or foamed consistency (viscosity), into contact with the backing layer substantially immediately after plasma treatment, such as a corona discharge treatment. Separate testing of treated fiberglass backing layers was conducted and it was determined that strikethrough was dramatically improved as the naturally hydrophobic fiberglass was found to be more hydrophilic after treating. This observation led to the conclusion that significantly less PVC could be used in the manufacture of the backing. In this way, the “porosity” of the discharge-treated fiberglass was increased such that the thermoplastic layer entered newly formed interstices in the fiberglass. As this occurred, adherence of the polyolefin layers through the fiberglass significant and measurably increased. Indeed, when the same amount of PVC (84 g/yd²) was applied to the corona-treated side of the fiberglass, adherence increased 23% (See Example 1). Therefore, it is believed that a significant reduction in PVC (preferably between from about 70 g/yd² to about 120/yd² applied in total to both sides of the fiberglass) can be effected while still providing the required backing adherence to the carpet adequate to retain essential product quality and useful product life. By reducing the amount of PVC supplied to the backing, the total weight of the backing and the eventual weight of the finished carpet are significantly reduced. The cost savings realized from the PVC savings as well as the shipping cost savings realized from the lighter finished product results in significant manufacturing cost reductions.

Corona discharge is an electrical phenomenon that occurs when air is exposed to a voltage potential high enough to cause ionization, thereby changing it from an electrical insulator to a conductor of electricity. The typical corona discharge equipment used to accomplish this consists of a power supply, a high voltage transformer, and a treating station that can be configured depending upon the material being processed as would be readily understood by one skilled in the field of material surface treatment. As shown in FIG. 1, the discharge apparatus is located on the web such that the metal electrode from the discharge apparatus is suspended suitably proximate to the polyolefin/fiberglass interface. Preferably, an air gap of from about 0.5 inch to about 10 inches exists between the discharge electrode and the surface being treated. High voltage is impressed across this air gap causing it to ionize, forming a corona discharge directly between the bare electrode and the material being treated, in this case, the fiberglass. The power density required to successfully corona treat the fiberglass is dependent upon the web speed and other factors that would be understood by one skilled in the field of corona discharge surface treatments. It is further understood that the processes of the present invention are not dependant upon any single type of plasma discharge unit, but can be effected by any discharge unit capable of working with high line speed and particular geometries, preferably in a one-pass coverage. According to one embodiment of the present invention, the discharge unit must affect the fiberglass to the extent that superior strikethrough is achieved, without otherwise damaging, distorting, or otherwise adversely affecting the structural integrity of the back layer stabilizing component of choice, preferably fiberglass. The discharge unit should be portable, although, according to one preferred embodiment of the present invention, the discharge unit is fixedly mounted in the desired location One representative unit is sold commercially under the name Plasma-Jet® (Corotec Corp., Farmington, Conn.).

An ozone generator was used to produce ozone that was provided to the running web. The discharged ozone bonded with the liquid thermoplastic, preferably PVC, immediately prior to applying the liquid (molten) PVC to the carpet segment. A three-dimensional corona treatment applicator was used to modify both sides of the surface structure of the stabilizing layer (fiberglass). It is believed that the same effects could be generated using an ionization bar to provide corona surface treatment application to a wide web.

There are at least two adjustable parameters for the corona treatment applicator. These parameters include the air gap between the electrode of the corona treatment applicator and the surface being treated, and the coverage of the corona arc on the material surface. Although both parameters are adjustable, each are normally treated in a pass/fail capacity after initial set-up. The corona surface application can also be measured in terms of line speed (fpm) when being applied to some materials, such as fiberglass. It is believed that the primary purpose of the corona surface treatment of material surfaces, such as, fiberglass, is to remove inherent binding agents from the surface, and to improve wet material “flow through” into the interstices of the fiberglass. It was determined that this effect improved adhesion. To insure complete surface coverage of, for example, an 82″ wide web, no less than forty-six (46) three-dimensional discharge heads may be required. Only one ionization bar would be necessary per application point if the nature of the surface treatment is so harsh as to damage the carpet face. Otherwise, the three-dimensional discharge heads for surface treatment would provide superior coverage.

The adjustable operating parameters of the ozone generation equipment include the output knob (measured in kW), the air flow knob (measured in cfm) and the sparge bar placement (measured in proximity to both the ozone application point and the ozone production unit). The tested settings for the output knob were from about 100 to about 900 kW. The tested ranges for the air flow were from about 9 cfm to about 22 cfm. The tested range for the sparge bar placement was constant at about 1 inch horizontal and about 2 inches vertical from the carpet/backing “marriage point” after the second molten polyolefin delivery station. There are multiple ways to achieve the sparge bar set-up to produce the desired level of adhesion. The position of the ozone generation equipment in proximity to the application point was also constant.

According to the present invention, the production line not only corona plasma-treats the fiberglass/polyolefin interface, but ozone treatment is provided to the thermoplastic/carpet interface downstream from the corona discharge treatment site. The ozone treatment provided, results from the useful placement of an ozone generator and ozone delivery system designed to introduce ozone to the thermoplastic material (preferably PVC) layer applied to one side of the fiberglass to create a “fiberglass sandwich” between the two PVC layers. As shown in FIG. 1, the ozone is preferably directed to the web at the point where the carpet contacts the “uppermost” PVC layer of the twice-thermoplastic-coated fiberglass layer component 40. The ozone generator can be any system that is preferably self-contained and portable. The preferred ozone generator also preferably has a fresh air supply and power supply and a closed-loop recirculating cooling system as well as a high-frequency power supply, ozone reaction chamber and an applicator assembly. One such LC Series ozone generator is commercially available from Corotec Corp., (Farmington, Conn.). As is understood by those skilled in the surface treatment field, ozone generators convert atmospheric oxygen into ozone by exposing the oxygen to a high-voltage electrical discharge, separating the oxygen molecules into their atomic form, and allowing them to recombine as ozone molecules. The ozone gas is then delivered to the production line using an applicator or sparging tube configured to extend across the web at the desired interface point. Ozone concentration can be adjusted as desired, as would be readily apparent to one skilled in the field of corona discharge surface treatments. It is understood that the present invention recognizes that the corona treatment selected, as well as the location of the treatment placement on the web, is optimally selected to improve the adhesion of carpet and carpet backing layers to one another. The processes and apparatuses of the invention are contemplated and adaptable to work with layers of any state that are presented to the web (e.g. solids, liquids, gels, etc.).

The present invention therefore provides many advantages not realized before in the carpet industry. Through use of the innovative surface treatments incorporated into the carpet manufacturing web, the resulting product achieves greatly improved adherence of the carpet component to the backing layer. The backing component laminate that is produced exhibits superior quality due to the improved integrity of the bonding of the polyolefin, or other thermoplastic material (e.g. PVC) layers to the stabilizing component layer (fiberglass or polyurethane foam, etc.). This improved adherence allows far less thermoplastic meterial to be used in the manufacture of the backing component, resulting in a thinner backing layer that adheres to the carpet at adherence rates equal to or better than the standard, thicker conventional backing components. The thinner backing layers achieved according to the present processes, therefore result in a lighter overall finished carpet product, thus reducing shipping costs, material costs and imparting other advantages in terms of installation, and appearance. In addition, the improved strikethrough and adherence of the backing component allows for the use of a broader category of backing layer candidates that includes recycled materials, such as, for example, recycled thermoplastics and other non-virginal materials, thus improving the versatility of the carpet manufacturing processes, and further reducing the overall cost of manufacturing, as more economical materials of equal performance can be used.

The present invention also contemplates optionally positioning a plasma discharge treatment unit to treat the exterior surface of a backing material to be affixed to a carpet component. Alternatively, one embodiment of the present invention is directed to surface treating the exterior of the backing component of an assembled and finished carpet with a plasma discharge. It has been discovered that disruption of the exterior surface of a backing layer of a finished carpet, preferably a polyolefin or other thermoplastic, and most preferably a PVC-containing material, allows the carpet backing to adhere to a surface during installation to a pre-selected and desirable degree. The ability to tailor the degree of carpet adhesion to a substrate receiving a carpet during carpet installation is desirable for many reasons. An installed carpet must remain predictably stationary. However, conventional adhesives used during such carpet installation can complicate removal and repair. In addition, the extent to which a removed carpet is damaged during removal can impact the ability to recycle the removed carpet. In addition, commonly used adhesives leave a significant residue on the substrate itself, requiring additional substrate cleaning steps that delays or complicates carpet installation. The present invention therefore allows for less adhesive to be used, and potentially allows for new types of adhesive to be used, during installation. This reduction in applied adhesive during installation also results in a significant cost and time savings, and facilitates later carpet removal.

Thus, it is understood that the improved carpet manufacturing methods of the present invention yield an improved carpet product that facilitates and improves carpet installation into and onto all articles and living spaces for which carpet may be employed. That is, the present invention contemplates the installation of the improved carpeting onto flooring and wall covering in buildings, outdoor carpeting uses, enclosed and open air vehicles including, but not limited to wheeled vehicles, aircraft and watercraft, etc. All such installation “targets” herein are encompassed by the term “carpeting environments”.

### EXAMPLE 1

Ozone Generation Trial Results—Delamination Testing

A number of tests were run on finished carpet product, prepared according to embodiments of the present invention as illustrated in FIG. 1, to determine improvement in adherence of the backing layer to the carpet component by testing delamination. Delamination, for the purposes of the present invention testing protocol, is the separation of the primary and secondary carpet backing due to poor adhesion. A strip of carpet, a “header” was cut from a roll in a dimension of approximately six feet by one inch. Three samples were cut from the header or one from a tile sample approximately one inch×six inches using a clicker press and a one inch×six inches die. The six inch dimension should be in the machine direction. The three samples were taken from the #1 tile side also referred to as the “right”. The second sample was taken from the approximate center of the header. The third sample was taken from the #4 tile side of the header, also known as the “left”. The vinyl layer was then separated from the primary back by cutting away the vinyl layer with a carpet utility knife. The layers were pulled apart about 1 inch to allow the sample to be properly set in the Instron® destructive testing machine. The upper and lower limit collars of the Instron® machine were positioned so the sample clamps stop about 1 inch to about 1.5 inches apart. The upper jaw limit collar was then set to allow the jaws to separate about 12″, thus allowing the samples to be pulled nearly completely apart. The carpet side of the sample was placed in the lower clamp with the vinyl side placed in the upper clamp. The “break” setting was set at 74% with the Instron® placed in “track” mode.

The test was initiated with the sample testing allowed to run until all but about one-third of the sample is pulled apart at which point the test is terminated manually if the Instron® does not stop automatically. The upper jaw stop collar is then set at this point allowing the test to automatically complete the remaining two samples. When the machine stops or returns after pulling each sample, the “peak 2” button is pressed to obtain the highest reading. The results are shown at Table 1. The steps were repeated until each of the samples were pulled.

TABLE 1
Adherence testing of Untreated and Treated Carpet

| | Sample | | |
|---|---|---|---|
| | A - Untreated | | |
| Test Run | B - Treated | Average | % Difference |
| 1 | A | 13.424 | −21.20 |
| | B | 10.578 | |
| 2 | A | 7.27 | 14.42 |
| | B | 8.318 | |
| 3 | A | 8.934 | 1.63 |
| | B | 9.08 | |
| 4 | A | 8.742 | −1.51 |
| | B | 8.61 | |
| 5 | A | 7.892 | 10.06 |
| | B | 8.686 | |
| 6 | A | 10.678 | 11.01 |
| | B | 11.854 | |
| 7 | A | 9.44 | 1.10 |
| | B | 9.544 | |
| 8 | A | 5.494 | 11.29 |
| | B | 6.114 | |
| 9 | A | 14.378 | −25.16 |
| | B | 10.76 | |
| 10 | A | 11.566 | 36.23 |
| | B | 15.756 | |
| 11 | A | 7.521 | 10.89 |
| | B | 8.34 | |
| 12 | A | 10.5 | −4.23 |
| | B | 10.056 | |
| 13 | A | 9.6 | 33.48 |
| | B | 12.814 | |
| 14 | A | 11.101 | 8.12 |
| | B | 12.002 | |
| 15 | A | 13.442 | 6.35 |
| | B | 14.296 | |
| 16 | A | 13.678 | −10.31 |
| | B | 12.268 | |
| 17 | A | 11.918 | 0.37 |
| | B | 11.962 | |
| 18 | A | 12.624 | 17.00 |
| | B | 14.77 | |
| 19 | A | 7.982 | −1.68 |
| | B | 7.848 | |
| 20 | A | 8 | 117.65 |
| | B | 17.412 | |
| 21 | A | 6.2 | 58.35 |
| | B | 9.818 | |
| Average Increase | | | 22.69% |

The results show an average increase in delamination resistance of about 23% as a result of employing the processes of the present invention.

### EXAMPLE 2

Urethane Foam Delamination Testing

Carpet sections were submitted for delamination testing. “Headers” were provided as samples. “Headers” are understood to be a strip of carpet cut from a roll approximately six feet by one inch. The samples for testing were cut from the header or from a tile sample to sample dimensions of one inch×six inches using a clicker press and a one inch×six inches die. The six inch dimension was in the machine direction. Three samples were taken from the #1 tile side (the “right”), three samples were taken from the center of the header and three samples taken from the #4 tile side of the header (the “left”). The action back and urethane layers were attempted to be separated from the primary back by physically pulling the layers apart using an Instron® destructive testing machine. If during the tearing procedure, the foam, but not the primary backing separates, the delam test is considered “good”. The minimum accepatable value for separation force applied (e.g. peel strength) is 3.0 lbs as recorded on the Instron. Test results showing separation when force below 3.0 lbs. is applied is considered failing. Test results between 3 and 5 lbs. are considered questionable. Test results above 5.0 lbs. Are considered “good”. According to the present invention, the backing is preferably adhered to the carpet at a peel strength adherence rate of from about 3 lbs. to about 25 lbs. depending upon the desired finished properties of the carpet product, more preferably from about 5.0 lbs. to about 25 lbs.

For urethane action back carpet tiles, a delamination test was considered “good” if the urethane foam tears and there was no separation of the primary and secondary back at the adhesive layer. Easy separation of the primary and secondary backs or gummy adhesive at the separation were indications of questionable or failing lamination.

While the invention has been described in detail in connection with only a limited number of embodiments, it should be readily understood that the invention is not limited to such disclosed embodiments. Rather the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for making carpet comprising the steps of:
providing a stabilizing component to a web, said stabilizing component having a first and a second surface;
providing a surface modifying treatment located proximate to at least one surface of the stabilizing component;
applying the surface modifying treatment to at least one surface of the stabilizing component;
providing a material to at least one surface of the stabilizing component following surface treatment of the stabilizing component;
providing a carpet segment to a web in close proximity to the stabilizing component; and
contacting the carpet segment to the surface treated stabilizing component.

2. The method of claim 1, further comprising the steps of:
providing a surface modifying treatment to a stabilizing component/carpet segment interface; and
applying the surface modifying treatment to the stabilizing component/carpet segment interface.

3. The method of claim 2, wherein the surface modifying treatment is applied to the stabilizing component.

4. The method of claim 2, wherein the surface modifying treatment is applied to the carpet segment.

5. A method for making carpet comprising the steps of:
providing a stabilizing component to a web, said stabilizing component having a first and a second surface;
providing a surface modifying treatment located proximate to the first surface of the stabilizing component;
applying the surface modifying treatment to the first surface of the stabilizing component;
providing a material to the first surface of the stabilizing component following surface treatment of the first surface of the stabilizing component;
providing a second material to the second surface of the stabilizing component;
providing a carpet material to a web in close proximity to the second material;
providing a surface modifying treatment to the second material;
applying the surface treatment to the second material; and
contacting the carpet to the surface treated second material.

6. The method of claim 5, wherein the stabilizing component comprises a material selected from the group consisting of: fiberglass, and fiberglass-containing material.

7. The method of claim 5, wherein the first and second materials comprise a material selected from the group consisting of polyurethane and foamable polyurethane.

8. The method of claim 5, wherein the first and second materials comprise materials selected from the group consisting of: poly(vinyl chloride)-containing material, polyvinylbutyral-containing material, [bitumen-containing materials,] and mixtures thereof.

9. The method of claim 5, wherein the first and second materials comprise recycled polyolefins.

10. The method of claim 5, wherein the first and second materials comprise polyvinyl chloride.

11. The method of claim 5, wherein the first and second materials comprise a thermoplastic material in a solid, liquid or foamed state.

12. The method of claim 5, wherein the surface modifying treatment is selected from the group consisting of: corona treatment; and ozone treatment.

13. The method of claim 5, wherein the surface modifying treatment used to treat the stabilizing component is a plasma discharge treatment.

14. The method of claim 5, wherein the surface modifying treatment used to treat the second substrate is an ozone treatment.

15. The method of claim 5, wherein the surface modifying treatment used to treat the stabilizing component improves the strikethrough of the first material through the surface of the stabilizing component.

16. The method of claim 5, wherein the surface modifying treatment used to treat the stabilizing component improves the strikethrough of the second material through the surface of the stabilizing component.

17. The method of claim 5, wherein the first and second materials in combination with the stabilizing component comprise a carpet backing.

18. The method of claim 17, wherein the second material is applied to the stabilizing component as a bond coat to adhere the backing to the carpet.

19. The method of claim 18, wherein the backing is adhered to the carpet at peel strength of from about 3 lbs. to about 25 lbs.

20. The method of claim 8, wherein the combined amount of first and second materials applied to the stabilizing component is from about 70 oz/yd² to about 120 oz/yd².

21. The method of claim 5, wherein the amount of thermoplastic containing material provided to the stabilizing component is less than or equal to about 60 oz/yd².

22. The method of claim 17, further comprising the step of:
modifying an exterior portion of a carpet backing by providing and applying a surface modifying treatment to the carpet backing exterior.

23. A carpet made according to the method of claim 1.

24. A carpet made according to the method of claim 5.

25. A carpet comprising:
a carpet component; and
a plasma-treated backing component comprising a stabilizing component having first and second surfaces, and a thermoplastic material coating both first and second surfaces in a total weight amount of from about 70 oz/yd² to about 120 oz/yd².

26. A method for making carpet comprising the steps of:
providing a first substrate to a web, said first substrate having a first and a second surface;
providing a first surface modifying treatment located proximate to the first surface of the first substrate;
applying the first surface modifying treatment to the first surface of the first substrate component;
providing a second substrate to the first surface of the first substrate following said first surface treatment of the first surface of the first substrate;
contacting the second substrate to the first surface of the first substrate;
providing a carpet to a web in close proximity to the second substrate; and
contacting the carpet to the second surface treated material.

27. The method of claim 26, wherein the first substrate is made from a material selected from the group consisting of: poly(vinyl chloride), polyvinylbutyral, bitumen, polymerically-modified bitumen, recycled polymeric material, and mixtures thereof.

28. The method of claim 27, wherein the first substrate is made from a thermoplastic material.

29. The method of claim 26, wherein the second substrate is made from an asphalt-containing material.

30. The method of claim 26, wherein the surface treatment is selected from the group consisting of corona plasma treatments and ozone treatments.

31. The method of claim 26, wherein the first surface treatment is a corona plasma treatment.

32. A carpet made according to the method of claim 26.

33. A carpet comprising:
a backing component comprising a first substrate, said first substrate having a plasma-treated first surface in contact with a second substrate; and
a carpet component adhered to the second substrate of the backing component.

34. The carpet of claim 33, wherein the second substrate is plasma treated substantially simultaneously as the carpet component is adhered to the second substrate.

35. The carpet of claim 33, wherein the second substrate is ozone-treated.

36. The carpet of claim 33 wherein the first substrate comprises a urethane-containing material.

37. The carpet of claim 36, wherein the urethane-containing material comprises a foamable material.

38. A carpeting environment comprising the carpet of claim 23.

39. A carpeting environment comprising the carpet of claim 24.

40. A carpeting environment comprising the carpet of claim 25.

41. A carpeting environment comprising the carpet of claim 32.

42. A carpeting environment comprising the carpet of claim 33.

43. A web apparatus for manufacturing carpet comprising:
a first station positioned along the web for making a backing component, said first station providing a surface treatment to at least one surface of a stabilizing component and providing a first material to a treated surface of the stabilizing component to create a backing component; and
a second station positioned along the web and downstream from the first station, said second station combining the backing layer with a carpet segment by providing a surface treatment to the backing component and contacting the carpet segment with the backing component.

44. The apparatus of claim 43, wherein the surface treatment comprises a plasma discharge treatment.

45. The apparatus of claim 44, wherein the surface treatment is selected from the group consisting of: corona plasma treatment and ozone treatment.

46. The apparatus of claim 43, wherein the second station further comprises providing a second material to a second treated surface of the stabilizing component and treating the surface of the second material.

47. The apparatus of claim 43, wherein a surface modifying treatment is provided to a stabilizing component/carpet segment interface prior to contacting the stabilizing component with the carpet segment.

48. The method of claim 5, wherein the first and second materials comprise bitumen-containing materials.
